(19) United States
(12) Patent Application Publication
(10) Pub. No.: US 2026/0280623 A1
(43) Pub. Date: Sep. 17, 2026

(54) PRECODER DESIGN FOR MIMO TRANSMISSION USING ORBITAL ANGULAR MOMENTUM MODES

(71) Applicant: LENOVO (BEIJING) LIMITED, Beijing (CN)

(72) Inventors: Chenxi Zhu, Beijing (CN); Bingchao Liu, Beijing (CN); Yi Zhang, Beijing (CN)

(21) Appl. No.: 19/471,541

(22) PCT Filed: Apr. 14, 2023
(86) PCT No.: PCT/CN2023/088397

§ 371 Date: Oct. 1, 2025

(51) Int. Cl. H04B 7/0456; H04B 7/10; H04B 17/345

(52) U.S. Cl. CPC H04B 7/0456; H04B 7/10; H04B 17/345

(57) ABSTRACT

Methods and apparatuses for OAM precoder are disclosed. In one embodiment, an OAM transmitter comprises TX antennas; and a processor, wherein, the processor is configured to: transmit, via the TX antennas, at least two OAM modes including OAM mode (l, p) and OAM mode (−l, p), where l is a positive integer and p is a non-negative integer, each OAM mode transmits one layer of signal in each utilized polarization; and apply a precoding matrix to the transmission of at least (l, p) and (−l, p) to mitigate the cross interference between (l, p) and (−l, p).

### FIELD

The subject matter disclosed herein generally relates to wireless communications, and more particularly relates to methods and apparatuses for precoder design for Multiple-Input Multiple-Output (MIMO) transmission using orbital angular momentum (OAM) modes.

### BACKGROUND

OAM is a candidate technology for 6G. OAM uses different electromagnetic wave propagation modes to transmit multiple streams of data in a line of sight environment.

This invention targets for precoder (i.e., precoding matrix) design for OAM receiver.

### BRIEF SUMMARY

Method and apparatus for OAM precoder are disclosed.

In one embodiment, an OAM transmitter comprises TX antennas; and a processor, wherein, the processor is configured to: transmit, via the TX antennas, at least two OAM modes including OAM mode (l, p) and OAM mode (−l, p), where l is a positive integer and p is a non-negative integer, each OAM mode transmits one layer of signal in each utilized polarization; and apply a precoding matrix to the transmission of at least (l, p) and (−l, p) to mitigate the cross interference between (l, p) and (−l, p).

In some embodiment, the precoding matrix has the form of two vectors, each of which has a phase shift coefficient associated with one of the two OAM modes. The phase shift coefficient associated with (l, p) and the phase shift coefficient associated with (−l, p) are derived from a same circular phase shift value (θ_{l,p}). In particular, the phase shift coefficient associated with (l, p) has an opposite sign to the phase shift coefficient associated with (−l, p).

In some embodiment, the processor is further configured to transmit, via the TX antennas, OAM mode (0, p₀) and/or one or multiple pairs of OAM mode (l_{N}, p_{N}) and OAM mode (−l_{N}, p_{N}), where N is one or multiple, wherein, the precoding matrix for (0, p) is [1], and the precoding matrix for each pair of (l_{N}, p_{N}) and (−l_{N}, p_{N}) is precoding matrix N with the same form as the precoding matrix for the pair of (l, p) and (−l, p), and the whole precoding matrix for all transmitted OAM modes are a block diagonal matrix composed of the precoding matrix for the pair of (l, p) and (−l, p) and the precoding matrix for (0, p₀) and/or the precoding matrix N for each pair of (l_{N}, p_{N}) and (−l_{N}, p_{N}). Further, each of precoding matrix for the pair of (l, p) and (−l, p), the precoding matrix for (0, p₀) and the precoding matrix N for each pair of (l_{N}, p_{N}) and (−l_{N} p_{N}) is applied with a power scaling factor g_{l,p}, g_{0,p}_{₀} and gₗ_{_{N}}_{,p}_{_{N}}, respectively.

In some embodiment, the processor is configured to transmit, via the TX antennas, at least four combinations of OAM modes and polarization directions including a combination of OAM mode (l, p) and polarization direction x ((l, p)ₓ), a combination of OAM mode (l, p) and polarization direction y ((l, p)_{y}), a combination of OAM mode (−l, p) and polarization direction x ((−l, p)ₓ) and a combination of OAM mode (−l, p) and polarization direction y ((−l, p)); and applying a precoding matrix to the transmission of at least (l, p)ₓ, (l, p)_{y}, (−l, p)ₓ and (−l, p)_{y} to mitigate the cross interference among (l, p)ₓ, (l, p)_{y}, (−l, p)ₓ and (−l, p)_{y}, where x and y are two orthogonal polarization directions.

In some embodiment, the precoding matrix has the form of four vectors, each of which has three phase shift coefficients associated with one of (l, p)ₓ, (l, p)_{y}, (−l, p)ₓ and (−l, p)_{y}. The three phase shift coefficients associated with each of (l, p)ₓ, (l, p)_{y}, (−l, p)ₓ and (−l, p)_{y} are derived from a same circular phase shift value (θ_{l,p}) and/or a same polarization phase shift value (η_{l,p}). Two of the three phase shift coefficients associated with one of (l, p)ₓ, (l, p)_{y}, (−l, p)ₓ and (−l, p)_{y} have an opposite sign to two of the three phase shift coefficients associated with any other of (l, p)ₓ, (l, p)_{y}, (−l, p)ₓ and (−l, p)_{y}.

In some embodiment, the processor is configured to further transmit, via the TX antennas, a combination of OAM mode (0, p₀) and polarization direction x ((0, p₀)ₓ) and a combination of OAM mode (0, p₀) and polarization direction y ((0, p₀)_{y}) and/or one or multiple sets of (l_{N}, p_{N})ₓ, (l_{N}, p_{N})_{y}, (−l_{N}, p_{N})ₓ, and (−l_{N}, p_{N})_{y}, where N is one or multiple, wherein the precoding matrix for (0, p₀)ₓ and (0, p₀)_{y} is a 2×2 matrix that is only associated with η_{0,p}_{₀}, and the whole precoding matrix for all transmitted combinations of OAM modes and polarization directions are a block diagonal matrix composed of the precoding matrix for the set of (l, p)ₓ, (l, p)_{y}, (−l, p)ₓ and (−l, p) and the precoding matrix for (0, p₀)ₓ and (0, p₀)_{y} and/or the precoding matrix for each set of (l_{N}, p_{N})ₓ, (l_{N}, p_{N})_{y}, (−l_{N}, p_{N})ₓ, and (−l_{N}, p_{N})_{y}. Further, each of precoding matrix for the set of (l, p)ₓ, (l, p)_{y}, (−l, p)ₓ and (−l, p)_{y}, the precoding matrix for (0, p₀)ₓ and (0, p₀)_{y} and the precoding matrix N for each set of (l_{N}, p_{N})ₓ, (l_{N}, p_{N})_{y}, (−l_{N}, p_{N})ₓ, and (−l_{N}, p_{N})_{y} is applied with a power scaling factor g_{l,p}, g_{0,p}_{₀} and gₗ_{_{N}}_{,p}_{_{N}}, respectively.

In another embodiment, a method performed at an OAM transmitter comprises transmitting, via the TX antennas, at least two OAM modes including OAM mode (l, p) and OAM mode (−l, p), where l is a positive integer and p is a non-negative integer, each OAM mode transmits one layer of signal in each utilized polarization; and applying a precoding matrix to the transmission of at least (l, p) and (−l, p) to mitigate the cross interference between (l, p) and (−l, p).

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method; and

FIG. 2 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In OAM Multiple-Input Multiple-Output (MIMO), different data streams are carried by different OAM modes. Each mode is characterized by (l, p) (i.e., a combination of l and p), where l is an integer (e.g., negative integer, 0 and positive integer) and p is non-negative integer (e.g., 0 and positive integer). In theory, these OAM modes remain orthogonal as they travel through the free space.

The receiver can receive these different OAM modes orthogonally only if the receiver is perfectly aligned with the transmitter. When the receiver is misaligned with the transmitter, e.g., is tilted, different OAM modes are no longer orthogonal, and accordingly, cross-modes interference (which may be referred to as cross interference) occurs. This is especially true for OAM modes with the same value of p and opposite value of l. For example, when the receiver is tilted, cross interference occurs between OAM mode (l, p) and OAM mode (l, p).

This disclosure proposes that, when appropriate precoding matrix is applied to the transmitted data streams at the transmitter side and receiver side, the cross interference can be mitigated or eliminated. This disclosure proposes the precoding matrix design for MIMO transmission using OAM modes.

The traditional MIMO precoding matrix is based on DFT matrices and their combinations. Traditional MIMO relies on the far field assumption. In addition, the channel is consisted of a set of different beams with different Angle of Arrival (AOA) and/or Direction of Arrival (DOA). The objective of the traditional MIMO precoding matrix is to capture these different beams for transmission. The orthogonality of these beams is guaranteed by the channel. Because the cross interference among different beams in the traditional MIMO, which is part of the multipath channel, can be absorbed naturally, the traditional MIMO precoding matrix can tolerate misalignment of the transmitter (e.g., transmitter (TX) antennas) and the receiver (e.g., receiver (RX) antennas).

On the other hand, in OAM MIMO, although OAM modes, that are used in OAM MIMO transmission, are orthogonal in space in theory, they are subject to cross interference when the receiver and the transmitter are not perfectly aligned.

So, the precoding matrix design for MIMO transmission using OAM modes is totally different from traditional MIMO precoding matrix design.

Under the paraxial approximation, the electromagnetic (EM) field of OAM mode (l, p) is described by the Laguerre-Gaussian modes in the following Equation (1):

$$\begin{matrix}u ( l , p , r , ϕ , z , t ) = {E}_{l , p} u ( l , p , r , z ) exp ( - il ϕ ) exp ( i ω t ) \\ = \begin{matrix}{C}_{lp}^{L G} \frac{{w}_{0}}{w ( z )} {( \frac{\sqrt{2} r}{w ( z )} )}^{\vert l \vert} exp ( - \frac{{r}^{2}}{{w}^{2} ( z )} ) {L}_{p}^{\vert l \vert} ( \frac{2 {r}^{2}}{{w}^{2} ( z )} ) exp ( - \frac{i k {w}_{0}^{2} {r}^{2} z}{2 {z}_{R}^{2} {w}^{2} ( z )} ) \\ exp ( - il ϕ ) exp ( i ( 2 p + \vert l \vert + 1 ) {tan}^{- 1} ( \frac{z}{{z}_{R}} ) ) exp ( - ikz ) exp ( i ω t )\end{matrix}\end{matrix} \qquad Equation ( 1 )$$

where, E_{l,p} is the initial amplitude of the electric field of mode (l, p),

$${L}_{p}^{\vert l \vert} ( x )$$

is a generalized Laguerre polynomial,

$${C}_{l , p}^{L G} = \sqrt{\frac{2 p !}{π ( p + \vert l \vert ) !}}$$

is the normalization factor (for nominal power),

$$w ( z ) = {w}_{0} \sqrt{1 + \frac{{z}^{2}}{{z}_{R}^{2}}}$$

is the radius of the beam at z, w₀ is the size of the beam waist,

$${z}_{R} = \frac{π {w}_{0}^{2} n}{λ}$$

is the Rayleigh range,

$$R ( z ) = z ( 1 + {( \frac{{z}_{R}}{z} )}^{2} )$$

is the radius of curvature at z, 1/R(z) is the curvature,

$$k = \frac{2 π}{λ}$$

is the wavevector,
r, φ, z are three ordinates in column coordinate, and ω is angular speed, t is time.

Different OAM modes correspond to different (l, p) (i.e., different combinations of l and p), and these OAM modes are orthogonal at the transmitter. In the following description, OAM mode can be abbreviated as mode.

When multiple modes are transmitted, each carrying its own signal x_{l,p}, the electric field is given by E(r, φ, z, t)=Σ_{(l,p)}E_{l,p}u(l, p, r, φ, z, t)x_{l,p}.

Because air is a linear medium, different modes do not mix. It means that different modes maintain orthogonality as they travel. The RX antenna placed at zᵣ uses the spatial and temporal receiving filter u*(l*, p*, r, φ, zᵣ, t) to receive mode (l*, p*) among all the transmitted modes.

The received signal for mode (l*, p*) with the proper RX antenna is:

$$\begin{matrix}{y}_{l , p} = {\int }_{ϕ = 0}^{2 π} {\int }_{r = 0}^{R} E ( r , ϕ , {z}_{r} , t ) {u}^{*} ( {l}^{*} , {p}^{*} , r , ϕ , {z}_{r} , t ) drd ϕ \\ = {\int }_{ϕ = 0}^{2 π} {\int }_{r = 0}^{R} {\sum }_{( l , p )} {E}_{l , p} u ( l , p , r , ϕ , {z}_{r} , t ) {x}_{l , p} {u}^{*} ( {l}^{*} , {p}^{*} , r , ϕ , {z}_{r} , t ) drd ϕ \\ = {\sum }_{( l , p )} {x}_{l , p} {E}_{l , p} {\int }_{ϕ = 0}^{2 π} {\int }_{r = 0}^{R} u ( l , p , r , ϕ , {z}_{r} , t ) {u}^{*} ( {l}^{*} , {p}^{*} , r , ϕ , {z}_{r} , t ) drd ϕ \\ = \begin{matrix}{\sum }_{( l , p )} {x}_{l , p} {E}_{l , p} {\int }_{ϕ = 0}^{2 π} {\int }_{r = 0}^{R} u ( l , p , r , {z}_{r} ) \\ exp ( - ilϕ ) exp ( iωt ) {u}^{*} ( {l}^{*} , {p}^{*} , r , z ) exp ( {il}^{*} ϕ ) \\ exp ( - i ω t ) drd ϕ\end{matrix} \\ = {\sum }_{( l , p )} {x}_{l , p} {E}_{l , p} δ ( l - {l}^{*} ) 2 π {\int }_{r = 0}^{R} u ( l , p , r , {z}_{r} ) {u}^{*} ( {l}^{*} , {p}^{*} , r , {z}_{r} ) dr \\ \approx {\sum }_{( l , p )} {x}_{l , p} {g}_{l , p} {E}_{l , p} δ ( l - {l}^{*} ) 2 π {\int }_{r = 0}^{∞} u ( l , p , r , {z}_{r} ) {u}^{*} ( {l}^{*} , {p}^{*} , r , {z}_{r} ) dr \\ = {\sum }_{( l , p )} {x}_{l , p} {g}_{l , p} {E}_{l , p} δ ( l - {l}^{*} ) δ ( p - {p}^{*} ) \\ = {g}_{{l}^{*} , {p}^{*}} {E}_{{l}^{*} , {p}^{*}} {x}_{{l}^{*} , {p}^{*}}\end{matrix}$$

where g_{l,p} is the channel gain for mode (l, p) from the transmitter to the receiver.

In matrix form Y=GEX (e.g., y_{l,p}=g_{l*,p*}E_{l*,p*}x_{l*,p*}), the matrix GE is a diagonal matrix consisting of the channel coefficients of different modes (l, p). By transmitting with multiple modes (l, p) and receiving the multiple modes (l, p) with their respective RX antennas, multiple degrees of freedom are achieved and multiple data layers can be transmitted in parallel.

There are several different ways to generate (transmit) and receive OAM signals, such as spiral phase plate (SPP), diffraction grating, spiral and twisted reflector, circular phase array, reflective or transmissive metasurface, etc. Due to implementation limit of the transmitter and the receiver, the most often used modes (l, p) are (0, 0), (±1, 0) (i.e., (1, 0) and (−1, 0)), (±2, 0) (i.e., (2, 0) and (−2, 0)), . . . , (±lₘₐₓ, 0) (i.e., (lₘₐₓ,0) and (−lₘₐₓ, 0)), where lₘₐₓ is an integer determined by the implementation limit.

In short distance communication, p>0 (such as p=1, 2) can also be used in the mode (l, p). The used modes depend on the type of transmitter (or receiver) and its size.

If Nₐₙₜ number of TX and RX antennas are arranged in transmitter and receiver (e.g., a typical uniform linear array (UCA)), respectively, if p=0, 2lₘₐₓ+1 different modes can be used simultaneously, where

$${l}_{max} \leq ⌊ \frac{{N}_{ant} - 1}{2} ⌋ .$$

Due to receiver imperfection, these different modes are often not orthogonal when they are received at the receiver side. This leads to the matrix GE non-diagonal. Such imperfection may be caused by phase offset or receiver imbalance at different TX or RX antennas on a UCA, misplacement or misshape or misalignment of the antennas, or limited transmitter size and/or receiver size. A transmitter or receiver can become out of alignment by wind or structure change of the antenna tower, or simply by a loose screw.

When this happens, different modes start to interfere to each other, and different data layers suffer from mutual interference. The modes that interfere strongly with each other are those modes with same p and opposite values of 1, i.e. (l, p) and (−l, p).

To mitigate the mutual interference between mode (l, p) and mode (−l, p), the transmitter can use an equalizer to equalize the cross interference between the modes (l, p) and (−l, p).

When the transmitter transmits a mode (l, p) in one of x and y polarization directions, the equalizer is a precoding matrix with the following type:

$${W}_{l , p}^{2} = [ \begin{matrix}1 & 1 \\ {e}^{j {θ}_{l , p}} & - {e}^{j {θ}_{l , p}}\end{matrix} ]$$

for transmission with up to 2 layers of data

$${s}^{2} = [ \begin{matrix}{s}_{1} \\ {s}_{2}\end{matrix} ] ,$$

where the parameter θ_{l,p}, which can be referred to as circular phase shift value, can be calculated by the receiver from the corresponding measured reference signals and sent back to the transmitter as part of the channel state information. The detailed implementation of calculation of θ_{l,p} is out of the scope of this disclosure.

The precoding matrix

$${W}_{l , p}^{2}$$

has the form of two vectors, e.g.,

$$[ \begin{matrix}1 \\ {e}^{j {θ}_{l , p}}\end{matrix} ] and [ \begin{matrix}1 \\ - {e}^{j {θ}_{l , p}}\end{matrix} ] .$$

Each vector has a phase shift coefficient, e.g., e^{jθ}^{_{l,p}} and −e^{jθ}l,p.

Two layers of data

$${s}^{2} = [ \begin{matrix}{s}_{1} \\ {s}_{2}\end{matrix} ]$$

can be transmitted as

$$[ \begin{matrix}{x}_{l , p} \\ {x}_{- l , p}\end{matrix} ] = {W}_{l , p}^{2} {s}^{2} ,$$

where x_{l,p} and x_{-l,p} are transmitted in mode (l, p) and (−l, p), respectively. It can be seen that each vector is associated with one of the mode (l, p) and the mode (−l, p). If only one layer of data is transmitted, the first vector (i.e., the first column) of

$${W}_{l , p}^{2} ( i . e . , [ \begin{matrix}1 \\ {e}^{j {θ}_{l , p}}\end{matrix} ] )$$

can be used as the equalizer.

Both the phase shift coefficients, e.g., e^{jθ}^{_{l,p}} and −e^{jθ}^{_{l,p}} are derived from the circular phase shift value θ_{l,p}. In addition, the two phase shift coefficients, e.g., e^{jθ}^{_{l,p}} and −e^{jθ}^{_{l,p}}, have an opposite sign.

When l=0, the two modes (l, p) and (−l, p) will be reduced mode (0, p), e.g., mode (0, 0) when p=0. So, there is no need for θ_{0,0}.

$${W}_{0 , 0}^{2} = [ 1 ]$$

is for the mode (0, 0).

The receiver can estimate the transmitted signal s² as

$$\text{?} = ( {W}_{l , p}^{2} {}^{H} {E}^{H} {G}^{H} {GEW}_{l , p}^{2} + \frac{I}{ρ} ) Y .$$

When the transmitter transmits a mode (l, p) in both x and y polarization directions, which are orthogonal, let (l, p)ₓ and (l, p)_{y} be the modes in x and y polarization directions, respectively. Misalignment of the receiver, such as unintentional tilt of the receiver disk, could lead to cross interference among (l, p)ₓ (i.e., a combination of mode (l, p) and x polarization direction), (−l, p)ₓ (i.e., a combination of mode (−l, p) and x polarization direction), (l, p)_{y} (i.e., a combination of mode (l, p) and y polarization direction) and (−l, p)_{y} (i.e., a combination of mode (−l, p) and y polarization direction), which are a total 4 different combinations of modes and polarization directions. To mitigate the cross interference among (l, p)ₓ, (−l, p)ₓ, (l, p)_{y} and (−l, p)_{y}, the transmitter can use an equalizer to equalize the cross interference among the 4 combinations of modes and polarization directions (e.g., (l, 0)ₓ, (−l, 0), (l, 0)_{y}, and (−l, 0)_{y} when p=0).

That is, when the transmitter transmits a mode (l, p) in both x and y polarization directions, the equalizer is a precoding matrix with the following type:

$${W}_{l , p}^{4} = [ \begin{matrix}1 & 1 & 1 & 1 \\ {e}^{j {θ}_{l , p}} & - {e}^{j {θ}_{l , p}} & {e}^{j {θ}_{l , p}} & - {e}^{j {θ}_{l , p}} \\ {e}^{j {η}_{l , p}} & {e}^{j {η}_{l , p}} & - {e}^{j {η}_{l , p}} & - {e}^{j {η}_{l , p}} \\ {e}^{j ( {θ}_{l , p} + {η}_{l , p} )} & - {e}^{j ( {θ}_{l , p} + {η}_{l , p} )} & - {e}^{j ( {θ}_{l , p} + {η}_{l , p} )} & {e}^{j ( {θ}_{l , p} + {η}_{l , p} )}\end{matrix} ]$$

for transmission to 4 layers of data

$${s}^{4} = [ \begin{matrix}{s}_{1} \\ {s}_{2} \\ {s}_{3} \\ {s}_{4}\end{matrix} ] ,$$

where the parameter θ_{l,p} (i.e., circular phase shift value), and the parameter η_{l,p}, which can be referred to as polarization phase shift value, can be calculated by the receiver from the corresponding measured reference signals and sent back to the transmitter as part of the channel state information. The detailed implementation of calculation of η_{l,p} is also out of the scope of this disclosure.

The precoding matrix

$${W}_{l , p}^{4}$$

has the form of four vectors, e.g.,

$$[ \begin{matrix}1 \\ {e}^{j {θ}_{l , p}} \\ {e}^{j {θ}_{l , p}} \\ {e}^{j ( {θ}_{l , p} + {η}_{l , p} )}\end{matrix} ] , [ \begin{matrix}1 \\ - {e}^{j {θ}_{l , p}} \\ {e}^{j {η}_{l , p}} \\ - {e}^{j ( {θ}_{l , p} + {η}_{l , p} )}\end{matrix} ] , [ \begin{matrix}1 \\ {e}^{j {θ}_{l , p}} \\ - {e}^{j {η}_{l , p}} \\ - {e}^{j ( {θ}_{l , p} + {η}_{l , p} )}\end{matrix} ] and [ \begin{matrix}1 \\ - {e}^{j {θ}_{l , p}} \\ - {e}^{j {η}_{l , p}} \\ {e}^{j ( {θ}_{l , p} + {η}_{l , p} )}\end{matrix} ] .$$

Each vector has three phase shift coefficients, e.g., e^{jθ}^{_{l,p}}, e^{jη}^{_{l,p}} and e^{j(θ}^{_{l,p}}^{+η}^{_{l,p}}⁾; −e^{jθ}^{_{l,p}}, e^{jη}^{_{l,p}} and −e^{j(θ}^{_{l,p}}^{+η}^{_{l,p}}⁾; e^{jθ}^{_{l,p}}, −e^{jη}^{_{l,p}} and −e^{j(θ}^{_{l,p}}^{+η}^{_{l,p}}⁾; and −e^{jθ}^{_{l,p}}, −e^{jη}^{_{l,p}} and e^{j(θ}^{_{l,p}}^{+η}^{_{l,p}}⁾.

The transmitted signal in four different combinations of modes and polarization directions

$${( l , p )}_{x} , {( - l , p )}_{x} , {( l , p )}_{y} , and {( - l , p )}_{y} is [ \begin{matrix}{x}_{{( l , p )}_{x}} \\ {x}_{{( - l , p )}_{x}} \\ {x}_{{( l , p )}_{y}} \\ {x}_{{( - l , p )}_{y}}\end{matrix} ] = {W}_{l , p}^{4} {s}^{4} .$$

It can be seen that each vector is associated with one of (l, p)ₓ, (−l, p)ₓ, (l, p)_{y}, and (−l, p)_{y}. If the number of layers R is less than 4 (i.e., R<4), first R columns of

$${W}_{l , p}^{4}$$

can be used.

The three phase shift coefficients associated with all of (l, p)ₓ, (−l, p)ₓ, (l, p)_{y}, and (−l, p)_{y}, i.e., e^{jθ}^{_{l,p}}, e^{jη}^{_{l,p}}, e^{j(θ}^{_{l,p}}^{+η}^{_{l,p}}⁾, −e^{jθ}^{_{l,p}}, −e^{jη}^{_{l,p}} and −e^{j(θ}^{_{l,p}}^{+η}^{_{l,p}}⁾ are derived from the circular phase shift value θ_{l,p} and the polarization phase shift value η_{l,p}. In addition, two of the three phase shift coefficients associated with one of (l, p)ₓ, (−l, p)ₓ, (l, p)_{y}, and (−l, p)_{y} have an opposite signa to two of the three phase shift coefficients associated with any other of (l, p)ₓ, (−l, p)ₓ, (l, p)_{y}, and (−l, p)_{y}. For example, among the three phase shift coefficients e^{jθ}^{_{l,p}}, e^{jη}^{_{l,p}} and e^{j(θ}^{_{l,p}}^{+η}^{_{l,p}}⁾, e^{jθ}^{_{l,p}} and e^{j(θ}^{_{l,p}}^{+η}^{_{l,p}}⁾ have an opposite sign to −e^{jθ}^{_{l,p}} and −e^{j(θ}^{_{l,p}}^{+η}^{_{l,p}}⁾ among −e^{jθ}^{_{l,p}}, e^{jη}^{_{l,p}} and −e^{j(θ}^{_{l,p}}^{+η}^{_{l,p}}⁾; e^{jη}^{_{l,p}}, e^{j(θ}^{_{l,p}}^{+η}^{_{l,p}}⁾ have an opposite sign to −e^{jη}^{_{l,p}} and −e^{j(θ}^{_{l,p}}^{+η}^{_{l,p}}⁾ among e^{jθ}^{_{l,p}}, −e^{jη}^{_{l,p}} and −e^{j(θ}^{_{l,p}}^{+η}^{_{l,p}}⁾; and e^{jθ}^{_{l,p}} and e^{jη}^{_{l,p}} have an opposite sign to −e^{jθ}^{_{l,p}} and e^{jη}^{_{l,p}} among −e^{jθ}^{_{l,p}}, −e^{jη}^{_{l,p}} and e^{j(θ}^{_{l,p}}^{+η}^{_{l,p}}⁾.

When l=0, the four combinations of modes and polarization directions will be reduced to (0, p)ₓ and (0, p)_{y}. Accordingly, there is no need for θ_{0,p}. So,

$${W}_{0 , p}^{4} = [ \begin{matrix}1 & 1 \\ {e}^{j {η}_{0 , p}} & - {e}^{j {η}_{0 , p}}\end{matrix} ]$$

is for (0,p)ₓ and (0,p)_{y}.

The receiver can estimate the transmitted signal s⁴ as

$$\text{?} = ( {W}_{l , p}^{{4}^{H}} {E}^{H} {G}^{H} G E {W}_{l , p}^{4} + \frac{I}{ρ} ) Y .$$

When more than one set of (l, p) and (−l, p) (e.g., (l₀, p₀) and (−l₀, p₀), (l₁, p₁) and (−l₁, p₁), . . . , (lₙ, pₙ) and (−lₙ, pₙ)) or more than one set of (lₙ, pₙ)ₓ, (−lₙ, pₙ)ₓ, (lₙ, pₙ)_{y}, and (−lₙ, pₙ)_{y} are transmitted simultaneously, a separate power scaling factor gₗ_{ₙ}_{,p}_{ₙ} can be applied to each set.

For linear polarization (only one polarization direction is used), the precoding matrix is a block diagonal matrix

$${W}^{2} = [ \begin{matrix}{g}_{{l}_{0} , {p}_{0}} {W}_{{l}_{0} , {p}_{0}}^{2} & 0 & … & 0 \\ 0 & {g}_{{l}_{1} , {p}_{1}} {W}_{{l}_{1} , {p}_{1}}^{2} & … & 0 \\ 0 & 0 & … & 0 \\ 0 & … & 0 & {g}_{{l}_{n} , {p}_{n}} {W}_{{l}_{n} , {p}_{n}}^{2}\end{matrix} ]$$

For cross polarization (i.e., two polarization directions are used), the precoding matrix is

$${W}^{4} = [ \begin{matrix}{g}_{{l}_{0} , {p}_{0}} {W}_{{l}_{0} , {p}_{0}}^{4} & 0 & … & 0 \\ 0 & {g}_{{l}_{1} , {p}_{1}} {W}_{{l}_{1} , {p}_{1}}^{4} & … & 0 \\ 0 & 0 & … & 0 \\ 0 & … & 0 & {g}_{{l}_{n} , {p}_{n}} {W}_{{l}_{n} , {p}_{n}}^{4}\end{matrix} ] ,$$

where (l₀, p₀), (l₁, p₁), . . . , (lₙ, pₙ) are different modes used for transmission.

As an example, when only l=0, ±1, ±2 (i.e., l₀=0, l₁=1, l₂=2) and p=0 (p₀=p₁=p₂=0) are used in one polarization direction (i.e., there are five modes (0, 0), (−1, 0), (1, 0), (−2, 0), and (2, 0)), the precoding matrix becomes

$${W}^{2} = [ \begin{matrix}{g}_{0 , 0} {W}_{0 , 0}^{2} & 0 & 0 \\ 0 & {g}_{1 , 0} {W}_{1 , 0}^{2} & 0 \\ 0 & 0 & {g}_{2 , 0} {W}_{2 , 0}^{2}\end{matrix} ] ,$$

in which

$${W}_{0 , 0}^{2}$$

is [1],

$${W}_{1 , 0}^{2} = [ \begin{matrix}1 & 1 \\ {e}^{j {θ}_{1 , 0}} & - {e}^{j {θ}_{1 , 0}}\end{matrix} ] , and {W}_{2 , 0}^{2} = [ \begin{matrix}1 & 1 \\ {e}^{j {θ}_{2 , 0}} & - {e}^{j {θ}_{2 , 0}}\end{matrix} ] .$$

So, W² is 5×5 matrix in this condition (i.e., l=0, ±1, ±2 and p=0 are used in one polarization direction).

Similarly, when only l=0, ±1, ±2 (i.e., l₀=0, l₁=1, l₂=2) and p=0 (p₀=p₁=p₂=0) are used in two polarization directions (i.e., there are 10 combinations of modes and polarization directions: (0, 0)ₓ and (0, 0)_{y}, (1,0)ₓ, (−1,0)ₓ, (1,0)_{y}, and (−1,0)_{y}, and (2,0)ₓ, (−2,0)ₓ, (2,0)_{y}, and (−2,0)_{y}), the precoding matrix

$${W}^{4} = [ \begin{matrix}{g}_{0 , 0} {W}_{0 , 0}^{4} & 0 & 0 \\ 0 & {g}_{1 , 0} {W}_{1 , 0}^{4} & 0 \\ 0 & 0 & {g}_{2 , 0} {W}_{2 , 0}^{4}\end{matrix} ] ,$$

in which

$${W}_{0 , 0}^{4} = [ \begin{matrix}1 & 1 \\ {e}^{j {η}_{0 , 0}} & - {e}^{j {η}_{0 , 0}}\end{matrix} ] ,$$

$${W}_{1 , 0}^{4} = [ \begin{matrix}1 & 1 & 1 & 1 \\ {e}^{j {θ}_{1 , 0}} & - {e}^{j {θ}_{1 , 0}} & {e}^{j {θ}_{1 , 0}} & - {e}^{j {θ}_{1 , 0}} \\ {e}^{j {η}_{1 , 0}} & {e}^{j {η}_{1 , 0}} & - {e}^{j {η}_{1 , 0}} & - {e}^{j {η}_{1 , 0}} \\ {e}^{j ( {θ}_{1 , 0} + {η}_{1 , 0} )} & - {e}^{j ( {θ}_{1 , 0} + {η}_{1 , 0} )} & - {e}^{j ( {θ}_{1 , 0} + {η}_{1 , 0} )} & {e}^{j ( {θ}_{1 , 0} + {η}_{1 , 0} )}\end{matrix} ] , and$$

$${W}_{2 , 0}^{4} = [ \begin{matrix}1 & 1 & 1 & 1 \\ {e}^{j {θ}_{2 , 0}} & - {e}^{j {θ}_{2 , 0}} & {e}^{j {θ}_{2 , 0}} & - {e}^{j {θ}_{2 , 0}} \\ {e}^{j {η}_{2 , 0}} & {e}^{j {η}_{2 , 0}} & - {e}^{j {η}_{2 , 0}} & - {e}^{j {η}_{2 , 0}} \\ {e}^{j ( {θ}_{2 , 0} + {η}_{2 , 0} )} & - {e}^{j ( {θ}_{2 , 0} + {η}_{2 , 0} )} & - {e}^{j ( {θ}_{2 , 0} + {η}_{2 , 0} )} & {e}^{j ( {θ}_{2 , 0} + {η}_{2 , 0} )}\end{matrix} ] .$$

So, W⁴ is 10×10 matrix in this condition (i.e., l=0, ±1, ±2 and p=0 are used in two polarization directions).

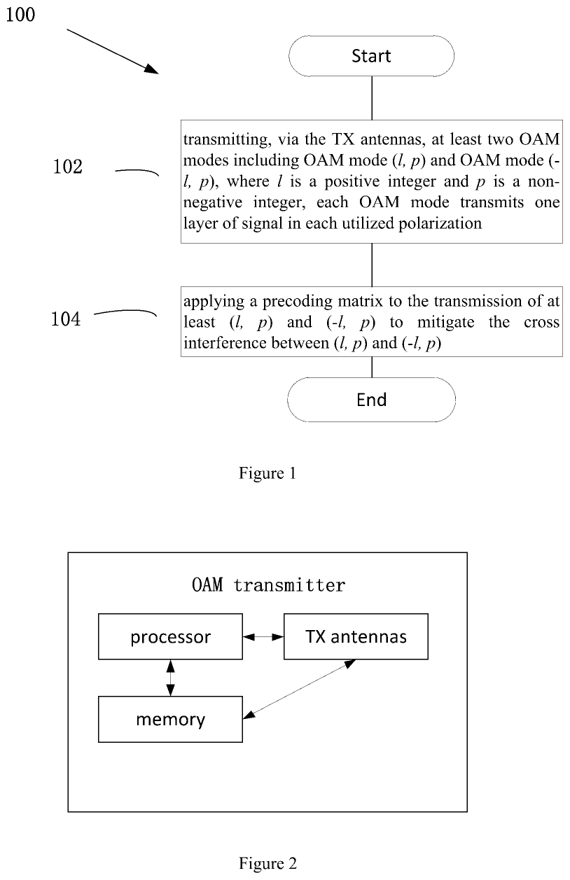

FIG. 1 is a schematic flow chart diagram illustrating an embodiment of a method 100 according to the present application. In some embodiments, the method 100 is performed by an apparatus, such as an OAM transmitter. In certain embodiments, the method 100 may be performed by a processor executing program code, for example, a microcontroller, a microprocessor, a CPU, a GPU, an auxiliary processing unit, a FPGA, or the like.

The method 100 is a method performed at an OAM transmitter including TX antennas, comprising: 102 transmitting, via the TX antennas, at least two OAM modes including OAM mode (l, p) and OAM mode (−l, p), where l is a positive integer and p is a non-negative integer, each OAM mode transmits one layer of signal in each utilized polarization; and 104 applying a precoding matrix to the transmission of at least (l, p) and (−l, p) to mitigate the cross interference between (l, p) and (−l, p).

In some embodiment, the precoding matrix has the form of two vectors, each of which has a phase shift coefficient associated with one of the two OAM modes. The phase shift coefficient associated with (l, p) and the phase shift coefficient associated with (−l, p) are derived from a same circular phase shift value (θ_{l,p}). In particular, the phase shift coefficient associated with (l, p) has an opposite sign to the phase shift coefficient associated with (−l, p).

In some embodiment, the method further comprises transmitting OAM mode (0, pᵤ) and/or one or multiple pairs of OAM mode (l_{N}, p_{N}) and OAM mode (−l_{N}, p_{N}), where N is one or multiple, wherein, the precoding matrix for (0, pᵤ) is [1], and the precoding matrix for each pair of (l_{N}, p_{N}) and (−l_{N}, p_{N}) is precoding matrix N with the same form as the precoding matrix for the pair of (l, p) and (−l, p), and the whole precoding matrix for all transmitted OAM modes are a block diagonal matrix composed of the precoding matrix for the pair of (l, p) and (−l, p) and the precoding matrix for (0, p₀) and/or the precoding matrix N for each pair of (l_{N}, p_{N}) and (−l_{N}, p_{N}). Further, each of precoding matrix for the pair of (l, p) and (−l, p), the precoding matrix for (0, p₀) and the precoding matrix N for each pair of (l_{N}, p_{N}) and (−l_{N}, p_{N}) is applied with a power scaling factor g_{l,p}, g_{0,p}_{₀} and gₗ_{_{N}}_{,p}_{_{N}}, respectively.

In some embodiment, the method comprises transmitting at least four combinations of OAM modes and polarization directions including a combination of OAM mode (l, p) and polarization direction x ((l, p)ₓ), a combination of OAM mode (l, p) and polarization direction y ((l, p)_{y}), a combination of OAM mode (−l, p) and polarization direction x ((−l, p)ₓ) and a combination of OAM mode (−l, p) and polarization direction y ((−l, p)_{y}); and applying a precoding matrix to the transmission of at least (l, p)ₓ, (l, p)_{y}, (−l, p)ₓ and (−l, p)_{y} to mitigate the cross interference among (l, p)ₓ, (l, p)_{y}, (−l, p)ₓ and (−l, p)_{y}, where x and y are two orthogonal polarization directions.

In some embodiment, the precoding matrix has the form of four vectors, each of which has three phase shift coefficients associated with one of (l, p)ₓ, (l, p)_{y}, (−l, p)ₓ and (−l, p)_{y}. The three phase shift coefficients associated with each of (l, p)ₓ, (l, p)_{y}, (−l, p)ₓ and (−l, p)_{y} are derived from a same circular phase shift value (θ_{l,p}) and/or a same polarization phase shift value (η_{l,p}). Two of the three phase shift coefficients associated with one of (l, p)ₓ, (l, p)_{y}, (−l, p)ₓ and (−l, p)_{y} have an opposite sign to two of the three phase shift coefficients associated with any other of (l, p)ₓ, (l, p)_{y}, (−l, p)ₓ and (−l, p)_{y}.

In some embodiment, the method further comprises transmitting a combination of OAM mode (0, p₀) and polarization direction x ((0, p₀)ₓ) and a combination of OAM mode (0, p₀) and polarization direction y ((0, p₀)_{y}) and/or one or multiple sets of (l_{N}, p_{N})ₓ, (l_{N}, p_{N})_{y}, (−l_{N}, p_{N})ₓ, and (−l_{N}, p_{N})_{y}, where N is one or multiple, wherein the precoding matrix for (0, p₀)ₓ and (0, p₀)_{y} is a 2×2 matrix that is only associated with η_{0,p}_{₀} and the whole precoding matrix for all transmitted combinations of OAM modes and polarization directions are a block diagonal matrix composed of the precoding matrix for the set of (l, p)ₓ, (l, p)_{y}, (−l, p)ₓ and (−l, p)_{y} and the precoding matrix for (0, p₀)ₓ and (0, p₀)_{y} and/or the precoding matrix for each set of (l_{N}, p_{N})ₓ, (l_{N}, p_{N})_{y}, (−l_{N}, p_{N})ₓ, and (−l_{N}, p_{N})_{y}. Further, each of precoding matrix for the set of (l, p)ₓ, (l, p)_{y}, (−l, p)ₓ and (−l, p)_{y}, the precoding matrix for (0, p₀)ₓ and (0, p₀)_{y} and the precoding matrix N for each set of (l_{N}, p_{N})ₓ, (l_{N}, p_{N})_{y}, (−l_{N}, p_{N})ₓ, and (−l_{N}, p_{N})_{y} is applied with a power scaling factor g_{l,p}, g_{0,p}_{₀} and gₗ_{_{N}}_{,p}_{_{N}}, respectively.

FIG. 2 is a schematic block diagram illustrating apparatuses according to one embodiment.

Referring to FIG. 2, the OAM transmitter includes a processor, a memory, and TX antennas. The processor implements a function, a process, and/or a method which are proposed in FIG. 1.

The OAM transmitter comprises TX antennas; and a processor, wherein, the processor is configured to: transmit, via the TX antennas, at least two OAM modes including OAM mode (l, p) and OAM mode (−l, p), where l is a positive integer and p is a non-negative integer, each OAM mode transmits one layer of signal in each utilized polarization; and apply a precoding matrix to the transmission of at least (l, p) and (−l, p) to mitigate the cross interference between (l, p) and (−l, p).

In some embodiment, the precoding matrix has the form of two vectors, each of which has a phase shift coefficient associated with one of the two OAM modes. The phase shift coefficient associated with (l, p) and the phase shift coefficient associated with (−l, p) are derived from a same circular phase shift value (θ_{l,p}). In particular, the phase shift coefficient associated with (l, p) has an opposite sign to the phase shift coefficient associated with (−l, p).

In some embodiment, the processor is further configured to transmit, via the TX antennas, OAM mode (0, p₀) and/or one or multiple pairs of OAM mode (l_{N}, p_{N}) and OAM mode (−l_{N}, p_{N}), where N is one or multiple, wherein, the precoding matrix for (0, p₀) is [1], and the precoding matrix for each pair of (l_{N}, p_{N}) and (−l_{N}, p_{N}) is precoding matrix N with the same form as the precoding matrix for the pair of (l, p) and (−l, p), and the whole precoding matrix for all transmitted OAM modes are a block diagonal matrix composed of the precoding matrix for the pair of (l, p) and (−l, p) and the precoding matrix for (0, p₀) and/or the precoding matrix N for each pair of (l_{N}, p_{N}) and (−l_{N PAT}). Further, each of precoding matrix for the pair of (l, p) and (−l, p), the precoding matrix for (0, p₀) and the precoding matrix N for each pair of (l_{N}, p_{N}) and (−l_{N}, p_{N}) is applied with a power scaling factor g_{l,p}, g_{0,p}_{₀} and gₗ_{_{N}}_{,p}_{_{N}}, respectively.

In some embodiment, the processor is configured to transmit, via the TX antennas, at least four combinations of OAM modes and polarization directions including a combination of OAM mode (l, p) and polarization direction x ((l, p)ₓ), a combination of OAM mode (l, p) and polarization direction y ((l, p)_{y}), a combination of OAM mode (−l, p) and polarization direction x ((−l, p)ₓ) and a combination of OAM mode (−l, p) and polarization direction y ((−l, p)_{y}); and applying a precoding matrix to the transmission of at least (l, p)ₓ, (l, p)_{y}, (−l, p)ₓ and (−l, p)_{y} to mitigate the cross interference among (l, p)ₓ, (l, p)_{y}, (−l, p)ₓ and (−l, p)_{y}, where x and y are two orthogonal polarization directions.

In some embodiment, the precoding matrix has the form of four vectors, each of which has three phase shift coefficients associated with one of (l, p)ₓ, (l, p)_{y}, (−l, p)ₓ and (−l, p)_{y}. The three phase shift coefficients associated with each of (l, p)ₓ, (l, p)_{y}, (−l, p)ₓ and (−l, p)_{y} are derived from a same circular phase shift value (θ_{l,p}) and/or a same polarization phase shift value (η_{l,p}). Two of the three phase shift coefficients associated with one of (l, p)ₓ, (l, p)_{y}, (−l, p)ₓ and (−l, p)_{y} have an opposite sign to two of the three phase shift coefficients associated with any other of (l, p)ₓ, (l, p)_{y}, (−l, p)ₓ and (−l, p)_{y}.

In some embodiment, the processor is configured to further transmit, via the TX antennas, a combination of OAM mode (0, p₀) and polarization direction x ((0, p₀)ₓ) and a combination of OAM mode (0, p₀) and polarization direction y ((0, p₀)_{y}) and/or one or multiple sets of (l_{N}, p_{N})ₓ, (l_{N}, p_{N})_{y}, (−l_{N}, p_{N})ₓ, and (−l_{N}, p_{N})_{y}, where N is one or multiple, wherein the precoding matrix for (0, p₀)ₓ and (0, p₀)_{y} is a 2×2 matrix that is only associated with η_{0,p}_{₀}, and the whole precoding matrix for all transmitted combinations of OAM modes and polarization directions are a block diagonal matrix composed of the precoding matrix for the set of (l, p)ₓ, (l, p)_{y}, (−l, p)ₓ and (−l, p)_{y} and the precoding matrix for (0, p₀)ₓ and (0, p₀)_{y} and/or the precoding matrix for each set of (l_{N}, p_{N})ₓ, (l_{N}, MN)_{y}, (−l_{N}, p_{N})ₓ, and (−l_{N}, p_{N})_{y}. Further, each of precoding matrix for the set of (l, p)ₓ, (l, p)_{y}, (−l, p)ₓ and (−l, p)_{y}, the precoding matrix for (0, p₀)ₓ and (0, p₀)_{y} and the precoding matrix N for each set of (l_{N}, p_{N})ₓ, (l_{N}, p_{N})_{y}, (−l_{N}, p_{N})ₓ, and (−l_{N}, p_{N})_{y} is applied with a power scaling factor g_{l,p}, g_{0,p}_{₀} and gₗ_{_{N}}_{,p}_{_{N}}, respectively.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. An operations, administration, and maintenance (OAM) transmitter, comprising:
at least one memory; and
at least one processor coupled with the at least one memory and configured to cause the OAM transmitter to:
transmit at least two OAM modes including OAM mode (l, p) and OAM mode (−l, p), where us a positive integer and p is a non-negative integer, each OAM mode transmits one layer of signal in each utilized polarization; and
apply a precoding matrix to the transmission of at least (l, p) and (−l, p) to mitigate across interference between (l, p) and (−l, p).

2. The OAM transmitter of claim 1, wherein the precoding matrix has a form of two vectors, each of which has a phase shift coefficient associated with one of the two OAM modes.

3. The OAM transmitter of claim 2, wherein the phase shift coefficient associated with (l, p) and the phase shift coefficient associated with (−l, p) are derived from a same circular phase shift value (θ_{l,p}).

4. The OAM transmitter of claim 3, wherein the phase shift coefficient associated with (l, p) has an opposite sign to the phase shift coefficient associated with (−l, p).

5. The OAM transmitter of claim 1, wherein the at least one processor is configured to cause the OAM transmitter to transmit OAM mode (0, p₀) and/or one or multiple pairs of OAM mode (l_{N}, p_{N}) and OAM mode (−l_{N}, p_{N}), where Nis one or multiple, and wherein:
the precoding matrix for (0, p₀) is [1], and the precoding matrix for each pair of (l_{N}, p_{N}) and (−l_{N}, p_{N}) is precoding matrix N with the same form as the precoding matrix for the pair of (l, p) and (−l, p); and
the whole precoding matrix for all transmitted OAM modes are a block diagonal matrix composed of the precoding matrix for the pair of (l, p) and (−l, p) and the precoding matrix for (0, p₀) and/or the precoding matrix N for each pair of (l_{N}, p_{N}) and (−l_{N}, p_{N}).

6. The OAM transmitter of claim 1, wherein each of precoding matrix for a pair of (l, p) and (−l, p), the precoding matrix for (0, p₀) and the precoding matrix N for each pair of (l_{N}, p_{N}) and (−l_{N}, p_{N}) is applied with a power scaling factor g_{l,p}, g_{0,p}_{₀} and gₗ_{_{N}}_{,p}_{_{N}}, respectively.

7. The OAM transmitter of claim 1, wherein the at least one processor is configured to cause the OAM transmitter to:
transmit at least four combinations of OAM modes and polarization directions including a combination of OAM mode (l, p) and polarization direction x ((l, p)ₓ), a combination of OAM mode (l, p) and polarization direction y ((l, p)_{y}), a combination of OAM mode (−l, p) and polarization direction x ((−l, p)ₓ) and a combination of OAM mode (−l, p) and polarization direction y ((−l, p)_{y}), where x and y are two orthogonal polarization directions; and
apply a precoding matrix to the transmission of at least (l, p)ₓ, (l, p)_{y}, (−l, p)ₓ and (−l, p)_{y} to mitigate across interference among (l, p)ₓ, (l, p)_{y}, (−l, p)ₓ and (−l, p)_{y}.

8. The OAM transmitter of claim 7, wherein the precoding matrix has a form of four vectors, each of which has three phase shift coefficients associated with one of (l, p)ₓ, (l, p)_{y}, (−l, p)ₓ and (−l, p)_{y}.

9. The OAM transmitter of claim 8, wherein the three phase shift coefficients associated with each of (l, p)ₓ, (l, p)_{y}, (−l, p)ₓ and (−l, p)_{y} are derived from a same circular phase shift value (θ_{l,p}) and/or a same polarization phase shift value (η_{l,p}).

10. The OAM transmitter of claim 9, wherein two of the three phase shift coefficients associated with one of (l, p)ₓ, (l, p)_{y}, (−l, p)ₓ and (−l, p)_{y} have an opposite sign to two of the three phase shift coefficients associated with any other of (l, p)ₓ, (l, p)_{y}, (−l, p)ₓ and (−l, p)_{y}.

11. The OAM transmitter of claim 7, wherein the at least one processor is configured to cause the OAM transmitter to transmit a combination of OAM mode (0, p₀) and polarization direction x ((0, p₀)ₓ) and a combination of OAM mode (0, p₀) and polarization direction y ((0, p₀)_{y}) and/or one or multiple sets of (l_{N}, p_{N})ₓ, (UN, p_{N})_{y}, (−l_{N}, p_{N})ₓ, and (−l_{N}, p_{N})_{y}, where N is one or multiple, and wherein:
the precoding matrix for (0, p₀)ₓ and (0, p₀)_{y} is a 2×2 matrix that is only associated with η_{0,p}_{₀}; and
the whole precoding matrix for all transmitted combinations of OAM modes and polarization directions are a block diagonal matrix composed of the precoding matrix for the set of (l, p)ₓ, (l, p)_{y}, (−l, p)ₓ and (−l, p)_{y} and the precoding matrix for (0, p₀)ₓ and (0, p₀)_{y} and/or the precoding matrix for each set of (UN, p_{N})ₓ, (UN, p_{N})_{y}, (−l_{N}, p_{N})ₓ, and (−l_{N}, p_{N})_{y}.

12. The OAM transmitter of claim 11, wherein each of precoding matrix for the set of (l, p)ₓ, (l, p)_{y}, (−l, p)ₓ and (−l, p)_{y}, the precoding matrix for (0, p₀)ₓ and (0, p₀)_{y} and the precoding matrix N for each set of (l_{N}, p_{N})ₓ, (UN, p_{N})_{y}, (−l_{N}, p_{N})ₓ, and (−l_{N}, p_{N})_{y} is applied with a power scaling factor g_{l,p}, g_{0,p}_{₀} and gₗ_{_{N}}_{,p}_{_{N}}, respectively.

13. A method performed ban operations, administration, and maintenance (OAM) transmitter, the method comprising:
transmitting at least two OAM modes including OAM mode (l, p) and OAM mode (−l, p), where l is a positive integer and p is a non-negative integer, each OAM mode transmits one layer of signal in each utilized polarization; and
applying a precoding matrix to the transmission of at least (l, p) and (−l, p) to mitigate a cross interference between (l, p) and (−l, p).

14. The method of claim 13, wherein the precoding matrix has a form of two vectors, each of which has a phase shift coefficient associated with one of the two OAM modes.

15. The method of claim 14, wherein the phase shift coefficient associated with (l, p) and the phase shift coefficient associated with (−l, p) are derived from a same circular phase shift value (θ_{l,p}).

16. The method of claim 15, wherein the phase shift coefficient associated with (l, p) has an opposite sign to the phase shift coefficient associated with (−l, p).

17. The method of claim 13, further comprising transmitting OAM mode (0, p₀) and/or one or multiple pairs of OAM mode (l_{N}, p_{N}) and OAM mode (−l_{N}, p_{N}), where N is one or multiple, and wherein:
the precoding matrix for (0, p₀) is [1], and the precoding matrix for each pair of (l_{N}, p_{N}) and (−l_{N}, p_{N}) is precoding matrix N with the same form as the precoding matrix for the pair of (l, p) and (−l, p); and
the whole precoding matrix for all transmitted OAM modes are a block diagonal matrix composed of the precoding matrix for the pair of (l, p) and (−l, p) and the precoding matrix for (0, p₀) and/or the precoding matrix N for each pair of (l_{N}, p_{N}) and (−l_{N}, p_{N}).

18. The method of claim 13, wherein each of precoding matrix for a pair of (l, p) and (−l, p), the precoding matrix for (0, p₀) and the precoding matrix N for each pair of (l_{N}, p_{N}) and (−l_{N}, p_{N}) is applied with a power scaling factor g_{l,p}, g_{0,p}_{₀} and gₗ_{_{N}}_{,p}_{_{N}}, respectively.

19. The method of claim 13, further comprising:
transmitting at least four combinations of OAM modes and polarization directions including a combination of OAM mode (l, p) and polarization direction x ((l, p)ₓ), a combination of OAM mode (l, p) and polarization direction y ((l, p)_{y}), a combination of OAM mode (−l, p) and polarization direction x ((−l, p)ₓ) and a combination of OAM mode (−l, p) and polarization direction y ((−l, p)_{y}), where x and y are two orthogonal polarization directions; and
applying a precoding matrix to the transmission of at least (l, p)ₓ, (l, p)_{y}, (−l, p)ₓ and (−l, p)_{y} to mitigate across interference among (l, p)ₓ, (l, p)_{y}, (−l, p)ₓ and (−l, p)_{y}.

20. A processor for wireless communication, comprising:
at least one controller coupled with at least one memory and configured to cause the processor to:
transmit at least two OAM modes including OAM mode (l, p) and OAM mode (−l, p), where l is a positive integer and p is a non-negative integer, each OAM mode transmits one layer of signal in each utilized polarization; and
apply a precoding matrix to the transmission of at least (l, p) and (−l, p) to mitigate a cross interference between (l, p) and (−l, p).
